(19) United States
(12) Patent Application Publication
(10) Pub. No.: US 2010/0122561 A1
(43) Pub. Date: May 20, 2010

(54) Driving device for an electric lock latch

(76) Inventor: Pang-Cheng Lui, Yangmei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/591,169

(22) Filed: Nov. 12, 2009

(30) Foreign Application Priority Data
Nov. 14, 2008 (TW) 097220410

(51) Int. Cl. E05B 47/00

(52) U.S. Cl. 70/277

(57) ABSTRACT

A driving device for an electric lock latch, comprising: a) a housing; b) a motor positioned within the housing with a power output shaft secured to a drive shaft with a threaded portion; c) a spiral spring having an internal part fixed in the housing or at the motor, the middle part of the spiral spring having a threaded joint portion (with a smaller diameter) corresponding to the threaded portion of the drive shaft, the internal and external parts of the spiral spring not having the threaded connection to the threaded portion of the drive shaft; and d) a lock latch secured to the external part of the spiral spring. Unlike the conventional structure requiring an external power source, thereby leading to a complicated installation, the structure in accordance with the invention includes a drive shaft having a threaded portion for driving a spiral spring in threaded connection thereto. Moreover, the lock latch is connected at the external part of the spiral spring. As a result, the circular motion of the drive shaft is converted into the rectilinear motion of the spiral spring such that the lock latch is moved. In this way, the locked and unlocked state of the lock device may be changed by the movement of the lock latch. Accordingly, the lock structure and the installation thereof may be simplified. Meanwhile, the power-saving effect is achieved.

### BACKGROUND OF THE INVENTION

1. Field of the Invention

The invention relates to a driving device for an electric lock latch, and more particularly to a structure with a drive shaft having a threaded portion for driving a spiral spring in threaded connection thereto. Moreover, the lock latch is connected at the external part of the spiral spring. As a result, the circular motion of the drive shaft is converted into the rectilinear motion of the spiral spring such that the lock latch is moved. In this way, the locked and unlocked state of the lock device may be changed by the movement of the lock latch. Moreover, the structure of the invention can be applied to all kinds of lock devices.

2. Description of the Related Art

It is quite normal that the lock employs an electromagnetic valve to control the movement of the latch, thereby changing the locked or unlocked state. Such a structure is disclosed in the U.S. Pat. No. 6,082,791. However, the activation of the electromagnetic valve requires a large power consumption. Therefore, it is necessary to provide an external power source and a control unit for the electric lock latch using the electromagnetic valve. As a result, the installer must have the electronic knowledge and the installation skill, thereby causing much difficulty for the installer.

In order to move the lock latch via the electromagnetic valve, a motor may be used to impart a motion to the lock latch. U.S. Pat. No. 5,697,798 “MOTORIZED LOCK ACTUATORS”, U.S. Pat. No. 5,628,216 “LOCKING DEVICE” and U.S. Pat. No. No. 6,076,870 belong to such a structure. “Motorized electric strike” disclosed in U.S. Pat. No. 6,076,870 relates to an electric strike with a pivoting locking member for locking an electric strike in the closed position. The locking member is pivoted between the locked and unlocked positions by a low current motor. A drive pin pivotally engages the locking member. The motor rotates a roll pin threadably engaging the coil faces of a spring mounted to the drive pin. Rotation of the motor compresses or expands the spring to axially move the drive pin and thereby pivot the locking member between the locked and unlocked positions.

However, the structure according to the U.S. Pat. No. 6,076,870 employs a motor to impart a rotary motion to the roll pin, thereby biasing the spring in a retracted or extended position. In this way, the drive pin is axially moved to bring the locking member between the locked and unlocked positions. The spring is equidimensionally formed. The time to supply power to the motor must be exactly controlled to prevent the breakdown of the spring due to over-compression or over-extension when the spring is moved by the rotation of the roll pin. Moreover, the installation of the roll pin and the drive pin according to the U.S. Pat. No. 6,076,870 is complicated. Therefore, a further improvement is required.

### SUMMARY OF THE INVENTION

An object of the invention is to eliminate the above-mentioned drawbacks of the conventional equidimensional spring activated by a pin and to provide a driving device for an electric lock latch wherein the middle part of the spiral spring is constructed as the threaded joint portion having a smaller diameter in threaded connection to the threaded portion of the drive shaft. Moreover, the internal and external parts of the spiral spring have a larger diameter such that no threaded connection to the drive shaft is established. In other words, the drive shaft will be idly rotated at the internal and external parts of the spiral spring. As a result, the spring may be protected from damage due to over-compression or over-extension.

Another object of the invention is to provide a driving device for an electric lock latch that can be easily modularized and applied to all kinds of lock devices. Accordingly, the lock structure and the installation thereof may be simplified.

In order to achieve the above-mentioned objects, the invention includes:

a) a housing;

b) a motor positioned within the housing with a power output shaft secured to a drive shaft with a threaded portion;

c) a spiral spring having an internal part fixed in the housing or at the motor, the middle part of the spiral spring having a threaded joint portion (with a smaller diameter) corresponding to the threaded portion of the drive shaft, the internal and external parts of the spiral spring not having the threaded connection to the threaded portion of the drive shaft; and

d) a lock latch secured to the external part of the spiral spring.

Based upon the above-mentioned features, the housing includes a guide slot corresponding to the spiral spring, and lock latch includes an insertion portion fitting into the external part of the spiral spring, thereby creating a reliable connection between the lock latch and the spiral spring, and wherein a tail loop is formed at the external end of the spiral spring, and wherein a connection element passes through the tail loop for connecting the spiral spring to the lock latch. It is also possible that the lock latch includes a mounting sleeve fitting over the external part of the spiral spring, thereby creating a reliable connection between the lock latch and the spiral spring, and wherein a tail loop is formed at the external end of the spiral spring, and wherein a connection element passes through the mounting sleeve and the tail loop for connecting the spiral spring to the lock latch.

### BRIEF DESCRIPTION OF THE DRAWINGS

The accomplishment of this and other objects of the invention will become apparent from the following descriptions and its accompanying figures of which:

FIG. 1 is an exploded perspective view of a first embodiment of a driving device in accordance with the invention;

FIG. 2 is an perspective assembly view of the first embodiment of a driving device in accordance with the invention;

FIG. 3 is a cross-sectional view of the first embodiment of the structure of FIG. 2 with the lock latch in an extended position;

FIG. 4 is a cross-sectional view of the first embodiment of the structure of FIG. 2 with the lock latch in a retracted position;

FIG. 5 is an exploded perspective view of the full structure of the first embodiment of the invention applied to a cylinder lock;

FIG. 6 is an exploded perspective view of the partial structure of the first embodiment of the invention applied to a cylinder lock;

FIG. 7 is an perspective assembly view of a second embodiment of a driving device in accordance with the invention;

FIG. 8 is a cross-sectional view taken along with the line 8-8 of FIG. 7;

FIG. 9 is an schematic drawing of the second embodiment of the invention applied to a first type mortise lock; and

FIG. 10 is an schematic drawing of the second embodiment of the invention applied to a second type mortise lock.

### DETAILED DESCRIPTION OF THE PREFERRED EMBODIMENT

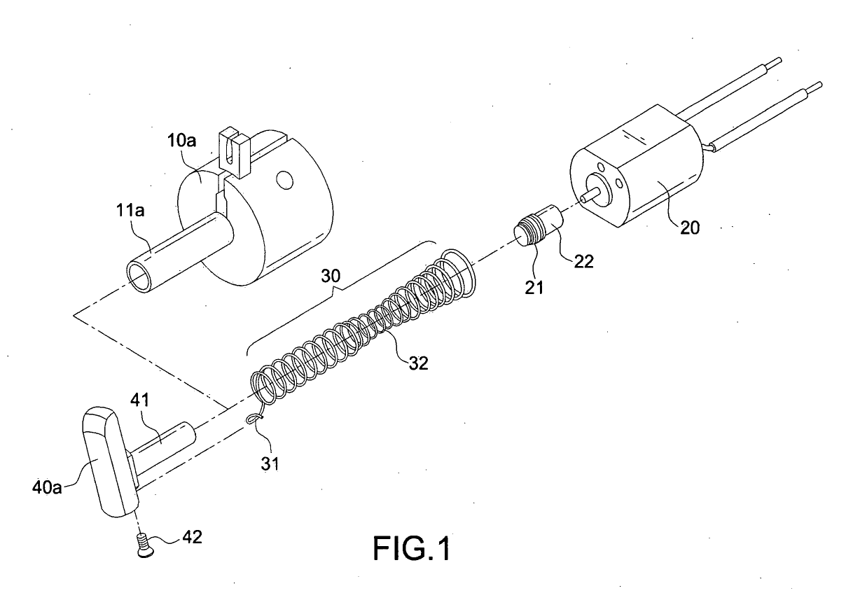

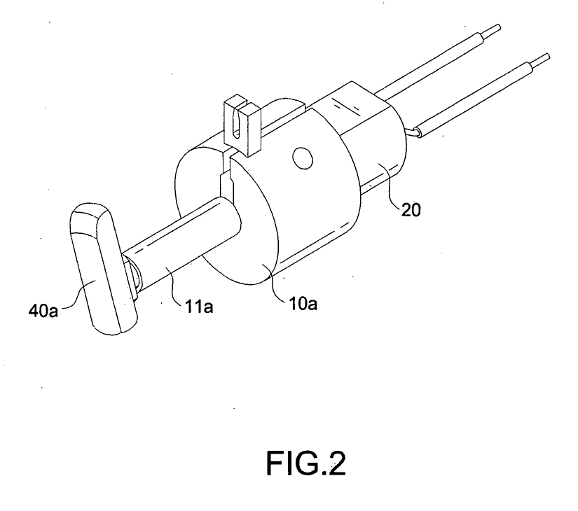

First of all, referring to FIGS. 1 and 2, a first embodiment of the structure in accordance with the invention includes a housing 10a, a motor 20, a spiral spring 30, and a lock latch 40a.

The motor 20 is positioned within the housing 10a with a power output shaft secured to a drive shaft 22 with a threaded portion 21.

The spiral spring 30 includes an internal part fixed in the housing 10a or at the motor 20. The middle part of the spiral spring 30 includes a threaded joint portion 32 (with a smaller diameter) corresponding to the threaded portion 21 of the drive shaft 22. The internal and external parts of the spiral spring 30 do not have the threaded connection to the threaded portion 21 of the drive shaft 22. The housing 10a further includes a guide slot 11a corresponding to the spiral spring 30.

The lock latch 40a is secured to the external part of the spiral spring 30. The lock latch 40a includes an insertion portion 41 fitting into the external part of the spiral spring 30, thereby creating a reliable connection between the lock latch 40a and the spiral spring 30. A tail loop 31 is formed at the external end of the spiral spring 30. Moreover, a connection element 42 such as screw passes through the tail loop 31 for connecting the spiral spring 30 to the lock latch 40a.

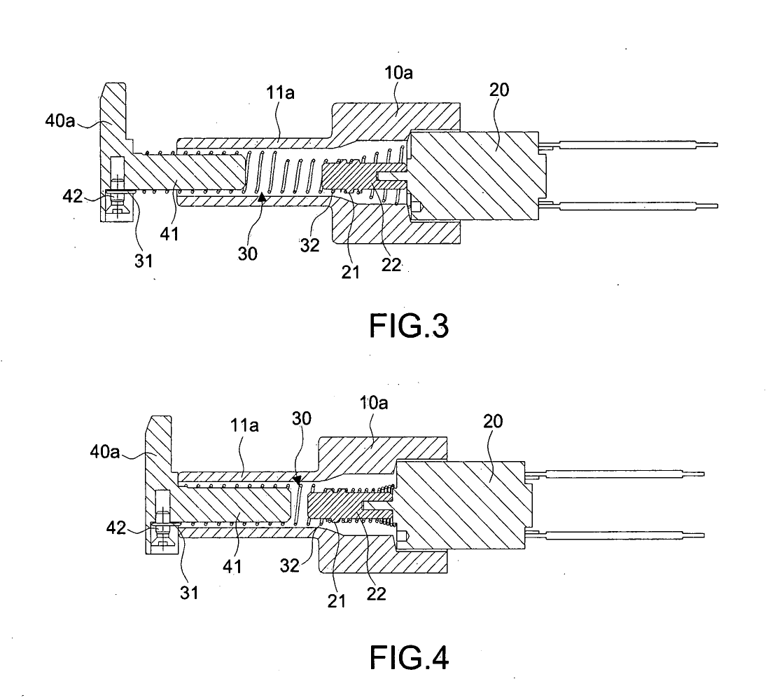

Based on the above-mentioned structure, the operation of the first embodiment of the invention is shown in FIGS. 3 and 4. When the motor 20 provides a driving power, the power will be transmitted through the threaded portion 21 of the drive shaft 22 to the threaded joint portion 32 of the spiral spring 30. The internal part is fixed in the housing 10a or at the motor 20. Therefore, the circular motion of the drive shaft 22 is converted into the rectilinear motion of the spiral spring 30. In other words, the spiral spring 30 is compressed in such a manner that the lock latch 40a secured to the external part of the spiral spring 30 is moved at the same time. Moreover, the guide slot 11a of the housing 10a ensures a smooth movement of the spiral spring 30 without departing from the prearranged path. In this way, the lock latch 40a may be moved to switch the lock in a locked or unlocked state.

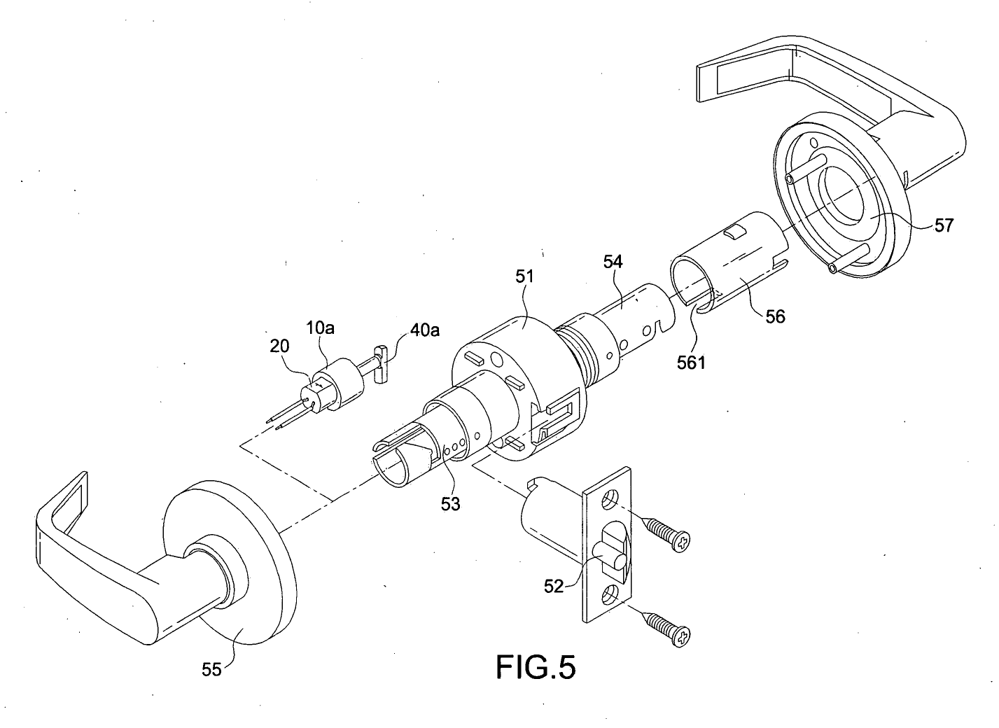

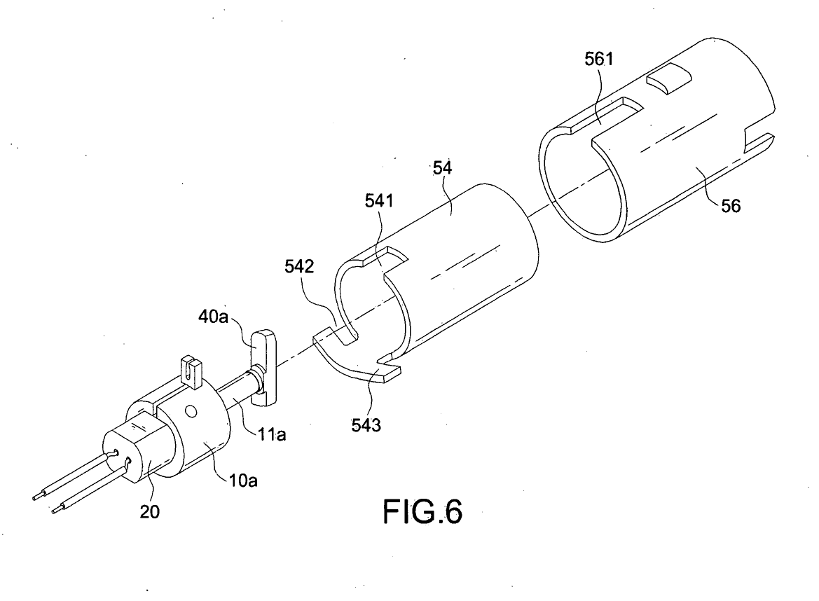

The structure in accordance with the first embodiment of the invention may be applied to a cylinder lock disclosed in the US2007/0182169A1 (see FIGS. 5 and 6). The cylinder lock employs a drive unit 51 to activate the door latch 52. The activation is done (by the drive unit 51) through the rotation of an internal drive tube 53 or an external drive tube 54. The internal drive tube 53 is coupled with an internal door handle 55 while an external sleeve 56 slips over the external drive tube 54. Moreover, the external sleeve 56 is coupled to an external door handle 57. The structure in accordance with the invention is installed within the internal drive tube 53 in such a manner that the lock latch 40a is directed to the external drive tube 54 and the external sleeve 56. The external sleeve 56 includes an axial clip-stop indentation 561 corresponding to the lock latch 40a. The external drive tube 54 includes an axial movement indentation 541 and a toroidal idle-rotation indentation 542. When the motor 20 gives out rotary power, the lock latch 40a will be moved within the axial clip-stop indentation 561 of the external sleeve 56. When the lock latch 40a is located in the toroidal idle-rotation indentation 542 of the external drive tube 54, the external sleeve 56 is rotated without the load of the external drive tube 54. In other words, the lock latch 40a can't rotate the external drive tube 54 to create an unlocked state. When the lock latch 40a is located in the axial movement indentation 541 of the external drive tube 54, the external sleeve 56 may impart a rotary motion to the external drive tube 54 by means of the lock latch 40a. In this way, the drive unit 51 may be activated by a convex ear 543. Thereafter, the door latch 52 may be driven by the drive unit 51 to unlock the door.

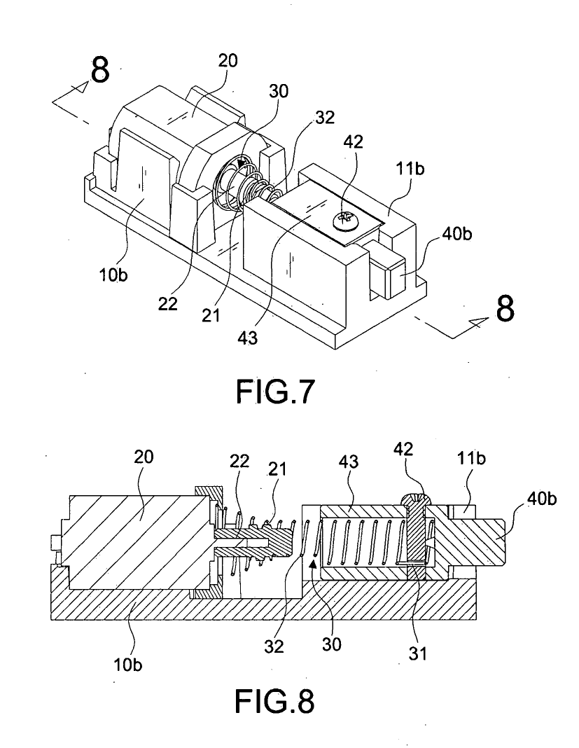

Referring to FIGS. 7 and 8, a second embodiment of the structure in accordance with the invention includes a housing 10b, a motor 20, a spiral spring 30, and a lock latch 40b.

The motor 20 is positioned within the housing 10b with a power output shaft secured to a drive shaft 22 with a threaded portion 21.

The spiral spring 30 includes an internal part fixed in the housing 10a or at the motor 20. The middle part of the spiral spring 30 includes a threaded joint portion 32 (with a smaller diameter) corresponding to the threaded portion 21 of the drive shaft 22. The internal and external parts of the spiral spring 30 do not have the threaded connection to the threaded portion 21 of the drive shaft 22. The housing 10b further includes a guide slot 11b corresponding to the spiral spring 30.

The lock latch 40b is secured to the external part of the spiral spring 30. The lock latch 40b includes an mounting sleeve 43 fitting over the external part of the spiral spring 30, thereby creating a reliable connection between the lock latch 40b and the spiral spring 30. A tail loop 31 is formed at the external end of the spiral spring 30. Moreover, a connection element 42 passes through the mounting sleeve 43 and the tail loop 31 for connecting the spiral spring 30 to the lock latch 40b.

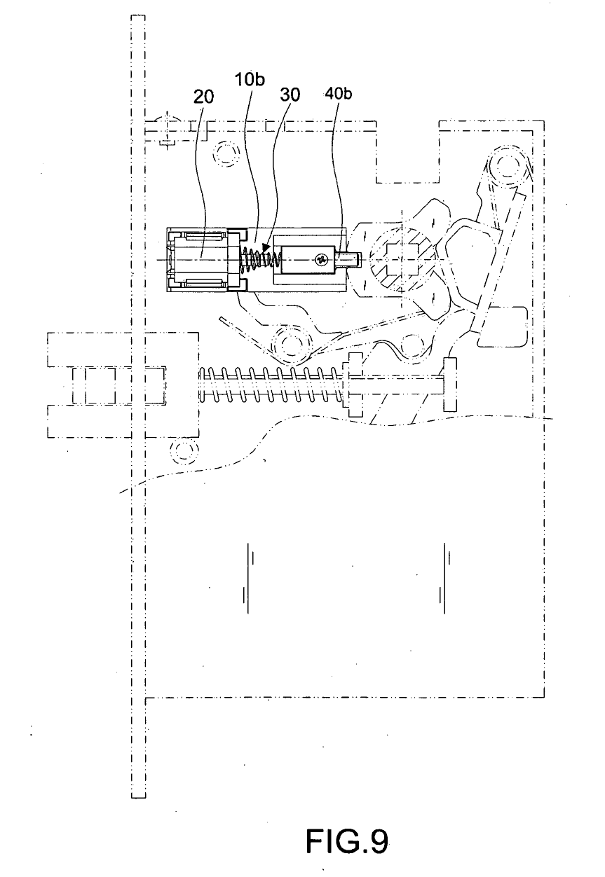

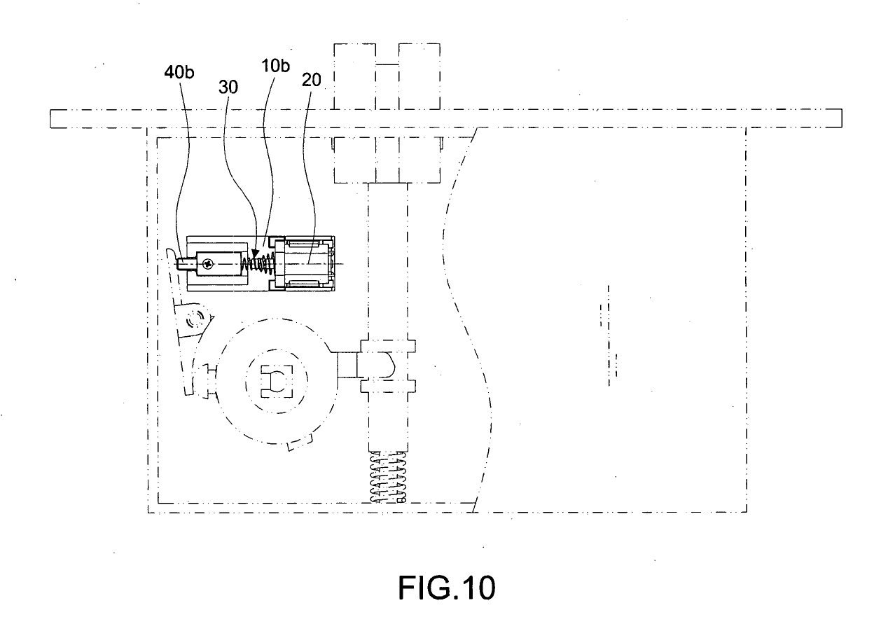

The structure in accordance with the second embodiment of the invention may be applied to a first type mortise lock (direct control locking element) and a second type mortise lock (indirect control locking element) (see FIGS. 9 and 10). The cylinder lock employs a drive unit 51 to activate the door latch 52. The structure of the invention has various applications that are not detailed hereinafter. In addition, they are not the object of the invention so that no further descriptions thereto are given hereinafter.

In summary, the drive shaft 22 having the threaded portion 21 is employed to drive the spiral spring 30 in threaded connection thereto. Moreover, the lock latch 40a, 40b is connected at the external part of the spiral spring 30. As a result, the circular motion of the drive shaft 22 is converted into the rectilinear motion of the spiral spring 30 such that the lock latch 40a, 40b is moved. In this way, the locked and unlocked state of the lock device may be changed by the movement of the lock latch 40a, 40b. The middle part of the spiral spring 30 is constructed as the threaded joint portion 32 having a smaller diameter. Moreover, the internal and external parts of the spiral spring have a larger diameter such that no threaded connection to the drive shaft is established. In other words, the drive shaft 22 will be idly rotated at the internal and external parts of the spiral spring 30. The movement position of the lock latch 40a, 40b may be controlled by the length of the threaded joint portion 32. As a result, it is not necessary to exactly control the duration of the power supply to the motor. In addition, the spring may be protected from damage due to over-compression or over-extension. Consequently, the motor 20 of the invention may activate the lock latch 40a, 40b with a slight power consumption to change its position. That is, the battery can supply the power needed. It is not necessary to connect to the mains. The structure and the assembly are both very simple. Accordingly, the lock structure and the installation thereof can be simplified.

What is claimed is:

1. A driving device for an electric lock latch, comprising:
a) a housing;
b) a motor positioned within the housing with a power output shaft secured to a drive shaft with a threaded portion;
c) a spiral spring having an internal part fixed in the housing or at the motor, the middle part of the spiral spring having a threaded joint portion (with a smaller diameter) corresponding to the threaded portion of the drive shaft, the internal and external parts of the spiral spring not having the threaded connection to the threaded portion of the drive shaft; and
d) a lock latch secured to the external part of the spiral spring.

2. The driving device for an electric lock latch as recited in claim 1 wherein the housing includes a guide slot corresponding to the spiral spring.

3. The driving device for an electric lock latch as recited in claim 2 wherein lock latch includes an insertion portion fitting into the external part of the spiral spring, thereby creating a reliable connection between the lock latch and the spiral spring, and wherein a tail loop is formed at the external end of the spiral spring, and wherein a connection element passes through the tail loop for connecting the spiral spring to the lock latch.

4. The driving device for an electric lock latch as recited in claim 2 wherein lock latch includes a mounting sleeve fitting over the external part of the spiral spring, thereby creating a reliable connection between the lock latch and the spiral spring, and wherein a tail loop is formed at the external end of the spiral spring, and wherein a connection element passes through the mounting sleeve and the tail loop for connecting the spiral spring to the lock latch.
